(19) United States
(12) Patent Application Publication
(10) Pub. No.: US 2026/0342625 A1
(43) Pub. Date: Oct. 29, 2026

(54) STYLUS AND DOWNLINK TRANSMISSION METHOD THEREOF

(71) Applicant: Novatek Microelectronics Corp., Hsinchu (TW)

(72) Inventor: Jiun-Jie Tsai, Hsinchu County (TW)

(73) Assignee: Novatek Microelectronics Corp., Hsinchu (TW)

(21) Appl. No.: 19/193,839

(22) Filed: Apr. 29, 2025

(51) Int. Cl. H04L 27/04; G06F 3/0354; G06F 3/038; G06F 3/041; H01Q 1/22; H04W 72/0453; H04W 72/23

(52) U.S. Cl. CPC H04L 27/04; G06F 3/03545; G06F 3/0383; G06F 3/04162; H01Q 1/22; H04W 72/0453; H04W 72/23; G06F 2203/0384

(57) ABSTRACT

Provided are a stylus and a downlink transmission method thereof. The stylus includes an antenna portion, a frequency allocator and a modulation circuit. The modulation circuit is coupled to the frequency allocator and the antenna portion. The frequency allocator divides a transmission data to be given to a sensing panel into multiple frequency channel data. The multiple frequency channel data respectively correspond to different downlink frequencies. The modulation circuit modulates each of multiple carriers having different downlink frequencies based on a corresponding one among the multiple frequency channel data to generate multiple modulated downlink signals having different downlink frequencies for the antenna portion. The antenna portion emits the modulated downlink signals to the sensing panel.

### BACKGROUND

### Technical Field

The disclosure relates to a touch device, and in particular relates to a stylus and a downlink transmission method thereof.

### Related Art

A user uses a stylus to perform a touch operation on a sensing panel. The stylus may emit a downlink signal to the sensing panel to allow the sensing panel to sense a position of the stylus on the sensing panel. Generally, the downlink signal emitted by the stylus is a single-frequency signal. The stylus utilizes phase-shift keying (PSK), binary phase-shift keying (BPSK), differential binary phase shift keying (DBPSK), quadrature phase-shift keying (QPSK) or differential quadrature phase-shift keying (DQPSK) to encode data bits onto the single-frequency signal, which serves as the downlink signal emitted by the stylus.

It should be noted that the content of the “Related Art” section is used to help understand the disclosure. Part (or all) of the content disclosed in the “Related Art” section may not be known technology to those skilled in the art. The content disclosed in the “Related Art” section does not imply that such content was known to those skilled in the art before the application of the disclosure.

### SUMMARY

The disclosure provides a stylus and a downlink transmission method thereof to transmit data to a sensing panel through multiple downlink frequencies.

In an embodiment of the disclosure, the foregoing stylus includes an antenna portion, a frequency allocator, and a modulation circuit. The frequency allocator divides a transmission data to be given to the sensing panel into multiple frequency channel data. The multiple frequency channel data respectively correspond to different downlink frequencies. The modulation circuit is coupled to the frequency allocator and the antenna portion. The modulation circuit modulates each of multiple carriers having different downlink frequencies based on a corresponding one among the multiple frequency channel data to generate multiple modulated downlink signals having different downlink frequencies for the antenna portion. The antenna portion emits the multiple modulated downlink signals to the sensing panel.

In an embodiment of the disclosure, the foregoing downlink transmission method includes: dividing a transmission data to be given to the sensing panel into multiple frequency channel data by a frequency allocator of the stylus, wherein the multiple frequency channel data respectively correspond to different downlink frequencies; modulating each of multiple carriers having different downlink frequencies based on a corresponding one among the multiple frequency channel data by a modulation circuit of the stylus to generate multiple modulated downlink signals having different downlink frequencies for an antenna portion of the stylus; and emitting the multiple modulated downlink signals to the sensing panel by the antenna portion.

Based on the above, according to the embodiments of the disclosure, the stylus divides the transmission data to be given to the sensing panel into the multiple frequency channel data corresponding to different downlink frequencies. Then, the multiple frequency channel data are respectively carried on the multiple carriers having different downlink frequencies to generate the multiple modulated downlink signals having different downlink frequencies. The stylus emits the multiple modulated downlink signals to the sensing panel. Therefore, the stylus may transmit data to the sensing panel through the multiple downlink frequencies.

In order to make the features and advantages of the disclosure more comprehensible, the following examples are given and described in detail with the accompanying drawings as follows.

### BRIEF DESCRIPTION OF THE DRAWINGS

FIG. 1 is a schematic diagram of an operation scenario of a touch system according to an embodiment of the disclosure.

FIG. 2 is a schematic diagram of a circuit block of a stylus according to an embodiment of the disclosure.

FIG. 3 is a flow chart of a downlink transmission method of a stylus according to an embodiment of the disclosure.

FIG. 4 is a schematic diagram of an antenna portion illustrated according to an embodiment of the disclosure.

FIG. 5 is a schematic diagram of an antenna portion illustrated according to another embodiment of the disclosure.

FIG. 6 is a schematic diagram of modulated downlink signals illustrated according to an embodiment of the disclosure.

FIG. 7 is a schematic diagram of modulated downlink signals illustrated according to another embodiment of the disclosure.

FIG. 8 is a schematic diagram of modulated downlink signals illustrated according to yet another embodiment of the disclosure.

FIG. 9 is a schematic diagram of modulated downlink signals illustrated according to another embodiment of the disclosure.

FIG. 10 is a schematic diagram of modulated downlink signals illustrated according to another embodiment of the disclosure.

FIG. 11 is a schematic diagram of modulated downlink signals illustrated according to yet another embodiment of the disclosure.

### DESCRIPTION OF THE EMBODIMENTS

In the entire specification of the disclosure (including the claims), the term “couple (or connect)” may refer to any direct or indirect connection means. For example, if the text describes that a first device is coupled (or connected) to a second device, it should be interpreted that the first device may be directly connected to the second device, or the first device may be indirectly connected to the second device through other devices or some connection means. The terms “first”, “second”, etc. mentioned in the entire specification of the disclosure (including the claims) are used to name elements or distinguish different embodiments or ranges, and are not used to limit the upper or lower limit of the number of elements, nor to limit the order of elements. In addition, where possible, the same reference numerals for elements/components/steps in the drawings and embodiments represent the same or similar parts. Elements/components/steps with the same reference numerals or using the same terms in different embodiments may refer to related descriptions.

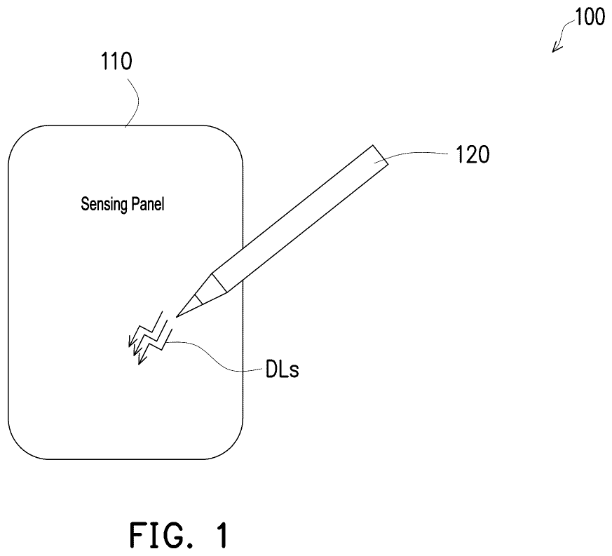

FIG. 1 is a schematic diagram of an operation scenario of a touch system 100 according to an embodiment of the disclosure. The touch system 100 shown in FIG. 1 includes a sensing panel 110 and a stylus 120. Based on actual application and design, the sensing panel 110 may be a touch panel, a touch display panel, or other sensing panel. The stylus 120 may emit downlink signals DLs having multiple downlink frequencies to the sensing panel 110 to allow the sensing panel 110 to sense a position of the stylus 120 on the sensing panel 110.

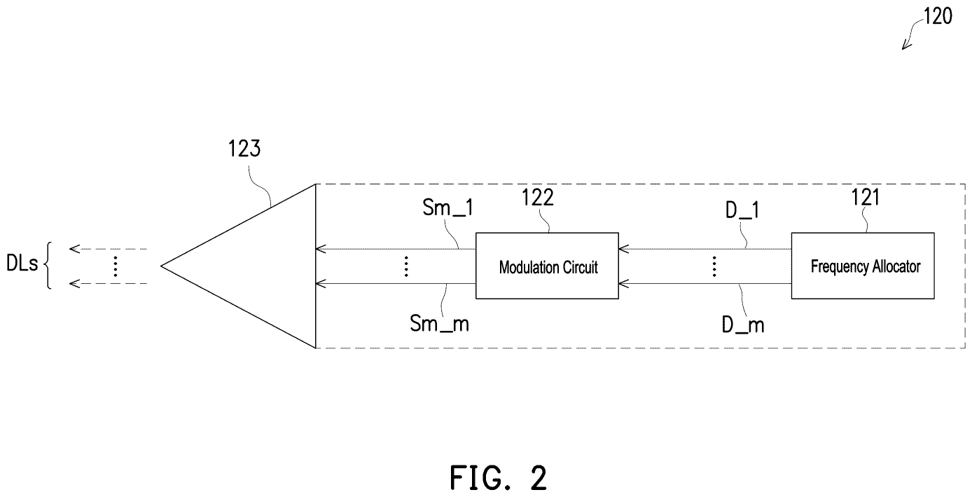

FIG. 2 is a schematic diagram of a circuit block of the stylus 120 according to an embodiment of the disclosure. The stylus 120 shown in FIG. 2 may serve as one of many embodiments of the stylus 120 shown in FIG. 1. The stylus 120 and the downlink signals DLs shown in FIG. 2 may refer to related descriptions of FIG. 1, so the details of which are not reproduced here. In the embodiment shown in FIG. 2, the stylus 120 includes a frequency allocator 121, a modulation circuit 122, and an antenna portion 123. Based on actual application and design, the antenna portion 123 includes one or more antennas. The modulation circuit 122 is coupled to the frequency allocator 121 and the antenna portion 123. According to different designs, in some embodiments, an implementation of the frequency allocator 121 and/or the modulation circuit 122 may be a hardware circuit. In other embodiments, an implementation of the frequency allocator 121 and/or the modulation circuit 122 may be in a combination form of multiple elements among the hardware, firmware, and software (that is, programs).

In terms of a hardware form, the foregoing frequency allocator 121 and/or the modulation circuit 122 may be implemented as a logic circuit on an integrated circuit. For example, related functions of the frequency allocator 121 and/or the modulation circuit 122 may be implemented in various logic blocks, modules, and circuits in one or more hardware controllers, microcontrollers, hardware processors, microprocessors, application-specific integrated circuits (ASIC), digital signal processors (DSP), field programmable gate arrays (FPGA), central processing units (CPU), and/or other processing units. The related functions of the frequency allocator 121 and/or the modulation circuit 122 may be implemented as hardware circuits, such as various logic blocks, modules, and circuits in integrated circuits, using hardware description languages (such as Verilog HDL or VHDL) or other suitable programming languages.

In terms of a software form and/or a firmware form, the related functions of the foregoing frequency allocator 121 and/or the modulation circuit 122 may be implemented as programming codes. For example, general programming languages (such as C, C++, or assembly language) or other suitable programming languages may be used to implement the frequency allocator 121 and/or the modulation circuit 122. The programming codes may be recorded/stored in a “non-transitory machine-readable storage medium”. In some embodiments, the non-transitory machine-readable storage medium may include a semiconductor memory and/or a storage device. Electronic devices (such as CPU, hardware controllers, microcontrollers, hardware processors, or microprocessors) may read and execute the programming codes from the non-transitory machine-readable storage medium, thereby implementing the related functions of the frequency allocator 121 and/or the modulation circuit 122.

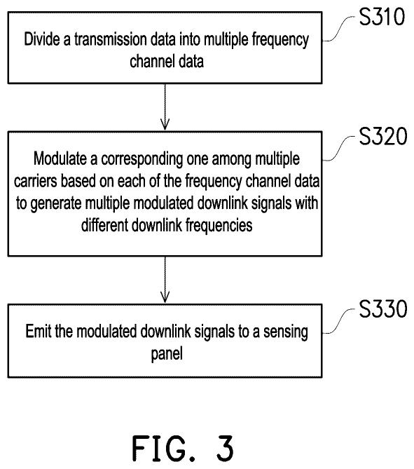

FIG. 3 is a flow chart of a downlink transmission method of a stylus according to an embodiment of the disclosure. Please refer to FIG. 2 and FIG. 3. In step S310, the frequency allocator 121 divides a transmission data to be given to the sensing panel 110 into multiple frequency channel data, such as m frequency channel data D_1, . . . , and D_m as shown in FIG. 2, where m is an integer determined based on the actual design. The multiple frequency channel data D_1 to D_m respectively correspond to different downlink frequencies. Based on actual operation and application, the transmission data may include an identification (ID) information of the stylus 120, a tip pressure information, a battery information, a key operation information, or other data.

The embodiment does not limit a specific implementation of the modulation circuit 122. For example, the modulation circuit 122 may include an on-off keying (OOK) modulator, an amplitude-shift keying (ASK) modulator, or other amplitude modulators. In step S320, the modulation circuit 122 modulates each of multiple carriers having different downlink frequencies based on a corresponding one among the multiple frequency channel data D_1 to D_m to generate multiple modulated downlink signals Sm_1, . . . , and Sm_m having different downlink frequencies. In step S330, the antenna portion 123 takes the modulated downlink signals Sm_1 to Sm_m to serve as the downlink signals DLs having different downlink frequencies and emits to the sensing panel 110.

In summary, the stylus 120 divides the transmission data to be given to the sensing panel 110 into the multiple frequency channel data D_1 to D_m corresponding to different downlink frequencies. Then, the multiple frequency channel data D_1 to D_m are respectively carried on the multiple carriers having different downlink frequencies to generate the multiple modulated downlink signals Sm_1 to Sm_m having different downlink frequencies. The stylus 120 takes the modulated downlink signals Sm_1 to Sm_m to serve as the downlink signals DLs and emits to the sensing panel 110. Therefore, the stylus 120 may transmit data to the sensing panel 110 through multiple downlink frequencies. Compared to single-frequency downlink signals emitted by a general stylus, the stylus 120 transmits data to the sensing panel 110 through multi-frequency downlink signals to accelerate a transmission of downlink data.

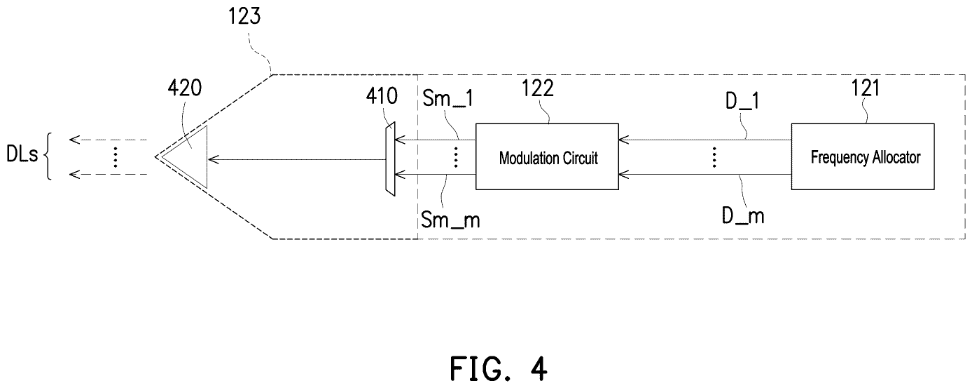

FIG. 4 is a schematic diagram of the antenna portion 123 illustrated according to an embodiment of the disclosure. In the embodiment shown in FIG. 4, the antenna portion 123 includes a multiplexer 410 and a tip antenna 420. An output terminal of the multiplexer 410 is coupled to the tip antenna 420. Multiple input terminals of the multiplexer 410 are coupled to the modulation circuit 122 to receive the modulated downlink signals Sm_1 to Sm_m. The multiplexer 410 outputs the modulated downlink signals Sm_1 to Sm_m to the tip antenna 420 in a time-division manner. The tip antenna 420 takes the modulated downlink signals Sm_1 to Sm_m output by the multiplexer 410 to serve as the downlink signals DLs and emits to the sensing panel 110.

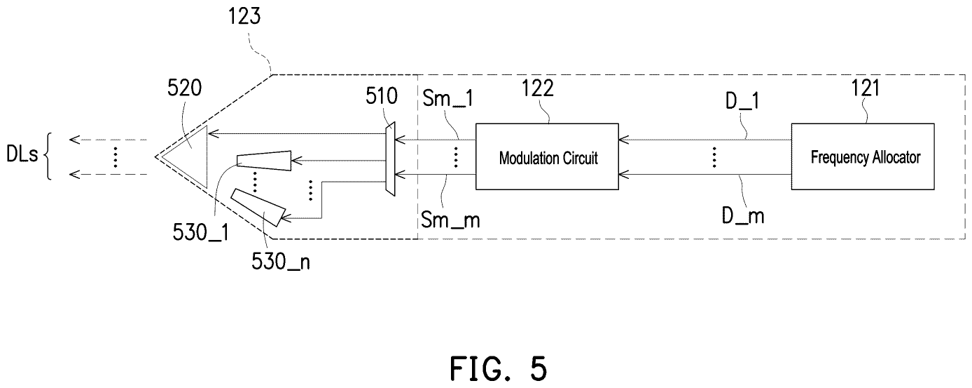

FIG. 5 is a schematic diagram of the antenna portion 123 illustrated according to another embodiment of the disclosure. In the embodiment shown in FIG. 5, the antenna portion 123 includes a multiplexer 510, a tip antenna 520, and at least one ring portion antenna. A quantity of the ring portion antennas may be determined according to the actual design and application. For example, the antenna portion 123 shown in FIG. 5 includes n ring portion antennas 530_1, . . . , and 530_n, where n is an integer determined based on the actual design. Multiple output terminals of the multiplexer 510 are respectively coupled to the tip antenna 520 and the ring portion antennas 530_1 to 530_n. Multiple input terminals of the multiplexer 510 are coupled to the modulation circuit 122 to receive the modulated downlink signals Sm_1 to Sm_m. The multiplexer 510 selectively outputs each of the modulated downlink signals Sm_1 to Sm_m to a corresponding antenna among the tip antenna 520 and the ring portion antennas 530_1 to 530_n. The tip antenna 520 and the ring portion antennas 530_1 to 530_n take the modulated downlink signals Sm_1 to Sm_m output by the multiplexer 510 to serve as the downlink signals DLs and emit to the sensing panel 110.

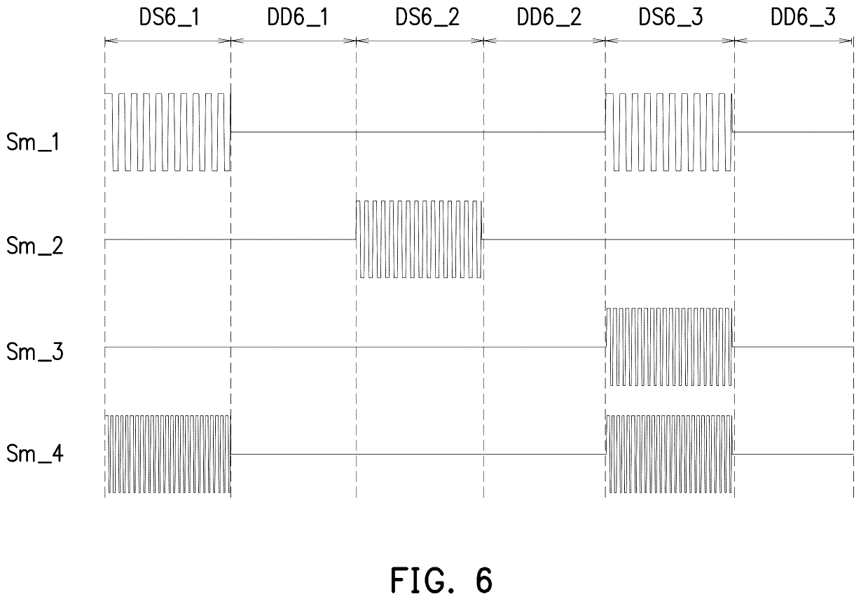

FIG. 6 is a schematic diagram of the modulated downlink signals Sm_1 to Sm_4 illustrated according to an embodiment of the disclosure. A horizontal axis of FIG. 6 represents time. In the embodiment shown in FIG. 6, a quantity m of the modulated downlink signals Sm_1 to Sm_m is assumed to be 4. To avoid interfering with a display driving operation of the sensing panel 110, downlink slots are staggered with display driving periods. Generally, each of the multiple downlink slots that are mutually discontinuous is located between two adjacent corresponding display driving periods in a display frame period of the sensing panel 110 (such as a touch display panel). Taking FIG. 6 as an example, downlink slots DS6_1, DS6_2, and DS6_3 are mutually discontinuous. The downlink slot DS6_2 is located between adjacent display driving periods DD6_1 and DD6_2. The downlink slot DS6_3 is located between adjacent display driving periods DD6_2 and DD6_3.

FIG. 6 shows an example of an on-off keying (OOK) modulation. Assume that 1 stylus frame includes N downlink slots, and a quantity of downlink frequencies (that is, the quantity m of the modulated downlink signals Sm_1 to Sm_m) is m. Based on the OOK, each stylus frame may transmit a total of (N*m*1) bits. For example, referring to FIG. 2 and FIG. 6, assume that the frequency allocator 121 divides a transmission data to be given to the sensing panel 110 into 4 frequency channel data D_1, D_2, D_3, and D_4. The modulation circuit 122 performs the OOK modulation on each of carriers based on a corresponding one among the multiple frequency channel data D_1 to D_4 to generate the modulated downlink signals Sm_1, Sm_2, Sm_3, and Sm_4 having different downlink frequencies for the antenna portion 123. The modulation circuit 122 modulates the frequency channel data D_1 on the modulated downlink signal Sm_1. The modulation circuit 122 modulates the frequency channel data D_2 on the modulated downlink signal Sm_2. The modulation circuit 122 modulates the frequency channel data D_3 on the modulated downlink signal Sm_3. The modulation circuit 122 modulates the frequency channel data D_4 on the modulated downlink signal Sm_4.

The modulation circuit 122 modulates the modulated downlink signals Sm_1 to Sm_4 for the antenna portion 123 in the downlink slots DS6_1, DS6_2, and DS6_3 based on the multiple frequency channel data D_1 to D_4. For example, the modulation circuit 122 respectively modulates a first portion, a second portion, and a third portion of the frequency channel data D_1 (assumed to be bit values “1”, “0”, and “1”) on the downlink slots DS6_1, DS6_2, and DS6_3 of the modulated downlink signal Sm_1. Similarly, a first portion, a second portion, and a third portion of the frequency channel data D_2 (assumed to be bit values “0”, “1”, and “0”) are respectively modulated on the downlink slots DS6_1, DS6_2, and DS6_3 of the modulated downlink signal Sm_2. A first portion, a second portion, and a third portion of the frequency channel data D_3 (assumed to be bit values “0”, “0”, and “1”) are respectively modulated on the downlink slots DS6_1, DS6_2, and DS6_3 of the modulated downlink signal Sm_3. A first portion, a second portion, and a third portion of the frequency channel data D_4 (assumed to be bit values “1”, “0”, and “1”) are respectively modulated on the downlink slots DS6_1, DS6_2, and DS6_3 of the modulated downlink signal Sm_4.

In some application scenarios, all bits of a same symbol in the transmission data are allocated to a same frequency channel data. The modulation circuit 122 carries the bits of the symbol on different downlink slots of a same modulated downlink signal. For example, assume that the transmission data includes a first symbol, a second symbol, a third symbol, and a fourth symbol. The modulation circuit 122 respectively carries three bits “1”, “0”, and “1” of the first symbol on the downlink slots DS6_1, DS6_2, and DS6_3 of the modulated downlink signal Sm_1, respectively carries three bits “0”, “1”, and “0 ” of the second symbol on the downlink slots DS6_1, DS6_2, and DS6_3 of the modulated downlink signal Sm_2, respectively carries three bits “0”, “0”, and “1” of the third symbol on the downlink slots DS6_1, DS6_2, and DS6_3 of the modulated downlink signal Sm_3, and respectively carries three bits “1”, “0”, and “1” of the fourth symbol on the downlink slots DS6_1, DS6_2, and DS6_3 of the modulated downlink signal Sm_4.

In other application scenarios, multiple bits of a same symbol in the transmission data are allocated to different frequency channel data. The modulation circuit 122 carries the bits of the same symbol on different modulated downlink signals within a same downlink slot. For example, assume that the transmission data includes a first symbol, a second symbol, and a third symbol. The modulation circuit 122 respectively carries bits “1”, “0”, “0”, and “1” of the first symbol on the same downlink slot DS6_1 of the different modulated downlink signals Sm_1 to Sm_4, respectively carries bits “0”, “1”, “0”, and “0 ” of the second symbol on the same downlink slot DS6_2 of the different modulated downlink signals Sm_1 to Sm_4, and respectively carries bits “1”, “0”, “1”, and “1” of the third symbol on the same downlink slot DS6_3 of the different modulated downlink signals Sm_1 to Sm_4.

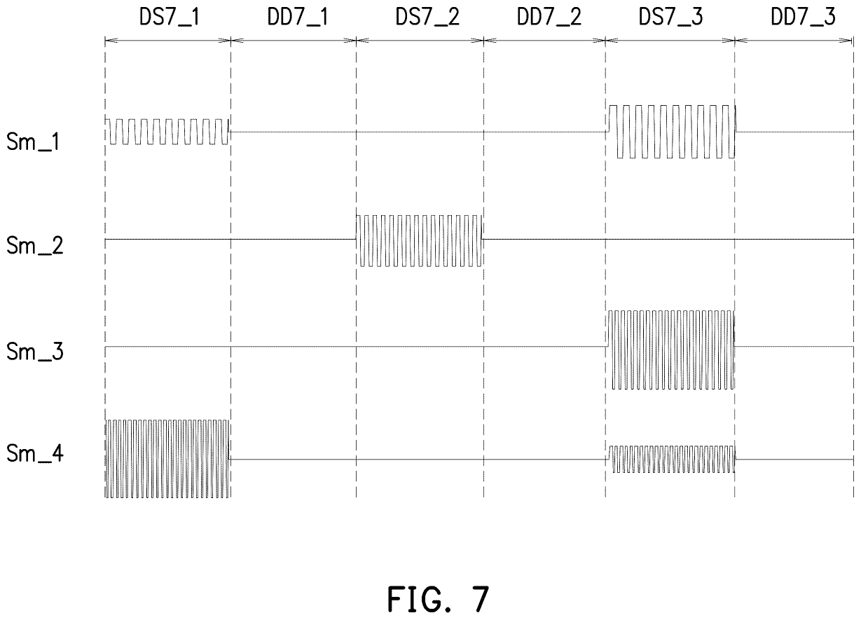

FIG. 7 is a schematic diagram of the modulated downlink signals Sm_1 to Sm_4 illustrated according to another embodiment of the disclosure. A horizontal axis in FIG. 7 represents time. In the embodiment shown in FIG. 7, the quantity m of the modulated downlink signals Sm_1 to Sm_m is assumed to be 4. The modulated downlink signals Sm_1 to Sm_4, downlink slots DS7_1 to DS7_3, and display driving periods DD7_1 to DD7_3 shown in FIG. 7 may be deduced by referring to the related descriptions of the modulated downlink signals Sm_1 to Sm_4, the downlink slots DS6_1 to DS6_3, and the display driving periods DD6_1 to DD6_3 shown in FIG. 6, so the details of which are not reproduced here.

FIG. 7 shows an example of an amplitude shift keying (ASK) modulation. Assume that 1 stylus frame includes N downlink slots. Assume that a quantity of downlink frequencies (that is, the quantity m of the modulated downlink signals Sm_1 to Sm_m) is m. Assume that the ASK may modulate 2\hat{ }B signal amplitudes. Based on the ASK, each stylus frame may transmit a total of (N*m*B) bits. For example, referring to FIG. 2 and FIG. 7, assume that the frequency allocator 121 divides the transmission data to be given to the sensing panel 110 into the 4 frequency channel data D_1, D_2, D_3, and D_4. The modulation circuit 122 performs the ASK modulation on each of carriers based on a corresponding one among the frequency channel data D_1 to D_4 to generate the modulated downlink signals Sm_1 to Sm_4 having different downlink frequencies for the antenna portion 123. In the embodiment shown in FIG. 7, a number of amplitude levels of the ASK modulation is assumed to be 4. A first amplitude (a minimum amplitude, such as 0) is assumed to be used to represent a bit value “00”. A second amplitude (greater than the first amplitude) is assumed to be used to represent a bit value “01”. A third amplitude (greater than the second amplitude) is assumed to be used to represent a bit value “10”. A fourth amplitude (greater than the third amplitude) is assumed to be used to represent a bit value “11”.

The modulation circuit 122 modulates the modulated downlink signals Sm_1 to Sm_4 for the antenna portion 123 in the downlink slots DS7_1, DS7_2, and DS7_3. For example, the modulation circuit 122 respectively modulates a first portion, a second portion, and a third portion of the frequency channel data D_1 (assumed to be bit values “01”, “00”, and “10”) in the downlink slots DS7_1, DS7_2, and DS7_3 of the modulated downlink signal Sm_1. Similarly, a first portion, a second portion, and a third portion of the frequency channel data D_2 (assumed to be bit values “00”, “10”, and “00”) are respectively modulated in the downlink slots DS7_1, DS7_2, and DS7_3 of the modulated downlink signal Sm_2. A first portion, a second portion, and a third portion of the frequency channel data D_3 (assumed to be bit values “00”, “00”, and “11”) are respectively modulated in the downlink slots DS7_1, DS7_2, and DS7_3 of the modulated downlink signal Sm_3. A first portion, a second portion, and a third portion of the frequency channel data D_4 (assumed to be bit values “11”, “00”, and “01”) are respectively modulated in the downlink slots DS7_1, DS7_2, and DS7_3 of the modulated downlink signal Sm_4.

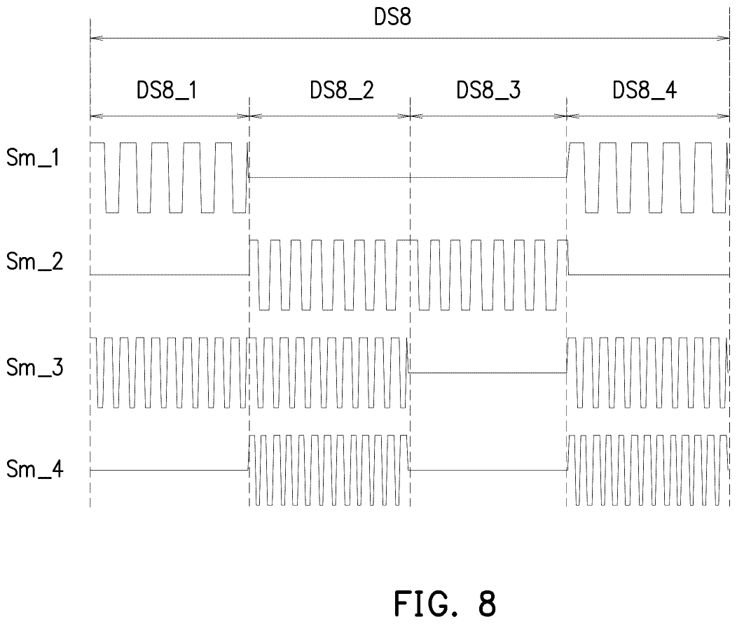

FIG. 8 is a schematic diagram of the modulated downlink signals Sm_1 to Sm_4 illustrated according to yet another embodiment of the disclosure. A horizontal axis in FIG. 8 represents time. In the embodiment shown in FIG. 8, the quantity m of the modulated downlink signals Sm_1 to Sm_m is assumed to be 4. The modulated downlink signals Sm_1 to Sm_4 shown in FIG. 8 may be deduced by referring to the related descriptions of the modulated downlink signals Sm_1 to Sm_4 shown in FIG. 6. A downlink slot DS8 shown in FIG. 8 may be deduced by referring to the related descriptions of any one of the downlink slots DS6_1 to DS6_3 shown in FIG. 6, so the details of which are not reproduced here.

FIG. 8 shows an example of each downlink slot including multiple sub-slots that are mutually continuous. Assume that 1 stylus frame includes N downlink slots. Assume that one downlink slot is divided into M sub-slots. Assume that a quantity of downlink frequencies (that is, the quantity m of the modulated downlink signals Sm_1 to Sm_m) is m. Based on the OOK, each stylus frame may transmit a total of (m*N*M*1) bits.

For example, please refer to FIG. 2 and FIG. 8. Assume that the frequency allocator 121 divides a transmission data to be given to the sensing panel 110 into the 4 frequency channel data D_1, D_2, D_3 and D_4. The downlink slot DS8 includes sub-slots DS8_1, DS8_2, DS8_3 and DS8_4 that are mutually continuous. The modulation circuit 122 performs the OOK modulation based on the multiple frequency channel data D_1 to D_4 to modulate the modulated downlink signals Sm_1 to Sm_4 for the antenna portion 123 in the sub-slots DS8_1 to DS8_4 of the downlink slot DS8. The modulation circuit 122 respectively modulates a first portion, a second portion, a third portion and a fourth portion of the frequency channel data D_1 (assumed to be bit values “1”, “0”, “0 ” and “1”) in the sub-slots DS8_1 to DS8_4 of the modulated downlink signal Sm_1 as shown in FIG. 8. Similarly, a first portion, a second portion, a third portion and a fourth portion of the frequency channel data D_2 (assumed to be bit values “0”, “1”, “1” and “0”) are respectively modulated in the sub-slots DS8_1 to DS8_4 of the modulated downlink signal Sm_2. A first portion, a second portion, a third portion and a fourth portion of the frequency channel data D_3 (assumed to be bit values “1”, “1”, “0 ” and “1”) are respectively modulated in the sub-slots DS8_1 to DS8_4 of the modulated downlink signal Sm_3. A first portion, a second portion, a third portion and a fourth portion of the frequency channel data D_4 (assumed to be bit values “0”, “1”, “0 ” and “1”) are respectively modulated in the sub-slots DS8_1 to DS8_4 of the modulated downlink signal Sm_4.

In some embodiments, the sensing panel 110 may detect the modulated downlink signals Sm_1 to Sm_m in the sub-slots DS8_1 to DS8_4 to perform coordinate positioning. For example (but not limited thereto), the sensing panel 110 may detect the modulated downlink signal Sm_1 in the sub-slot DS8_1, detect the modulated downlink signal Sm_3 in the sub-slot DS8_2, detect the modulated downlink signal Sm_2 in the sub-slot DS8_3, and detect the modulated downlink signal Sm_4 in the sub-slot DS8_4 to perform positioning on the coordinates of the stylus 120. In other embodiments, the antenna portion 123 may mix the modulated downlink signals Sm_1 to Sm_m to generate the downlink signals DLs to the sensing panel 110. Based on this, the sensing panel 110 may detect and use the downlink signal DLs that has been mixed to perform coordinate positioning.

In some application scenarios, all bits of a same symbol in the transmission data may be allocated to a same frequency channel data. The modulation circuit 122 may carry the bits of the symbol in different sub-slots of a same modulated downlink signal. For example, assume that the transmission data includes a first symbol, a second symbol, a third symbol, and a fourth symbol. The modulation circuit 122 may respectively carry three bits “1”, “0”, “0 ” and “1” of the first symbol in the sub-slots DS8_1, DS8_2, DS8_3 and DS8_4 of the modulated downlink signal Sm_1, respectively carry three bits “0”, “1”, “1” and “0 ” of the second symbol in the sub-slots DS8_1 to DS8_4 of the modulated downlink signal Sm_2, respectively carry three bits “1”, “1”, “0 ” and “1” of the third symbol in the sub-slots DS8_1 to DS8_4 of the modulated downlink signal Sm_3, and respectively carry three bits “0”, “1”, “0 ” and “1” of the fourth symbol in the sub-slots DS8_1 to DS8_4 of the modulated downlink signal Sm_4.

In other application scenarios, multiple bits of a same symbol in the transmission data may be allocated to different frequency channel data. The modulation circuit 122 may carry the bits of the same symbol on different modulated downlink signals within a same sub-slot. For example, assume that the transmission data includes a first symbol, a second symbol, a third symbol, and a fourth symbol. The modulation circuit 122 may respectively carry bits “1”, “0”, “1” and “0 ” of the first symbol in the same sub-slot DS8_1 of the different modulated downlink signals Sm_1 to Sm_4, respectively carry bits “0”, “1”, “1” and “1” of the second symbol in the same sub-slot DS8_2 of the different modulated downlink signals Sm_1 to Sm_4, respectively carry bits “0”, “1”, “0 ” and “0 ” of the third symbol in the same sub-slot DS8_3 of the different modulated downlink signals Sm_1 to Sm_4, and respectively carry bits “1”, “0”, “1” and “1” of the fourth symbol in the same sub-slot DS8_4 of the different modulated downlink signals Sm_1 to Sm_4.

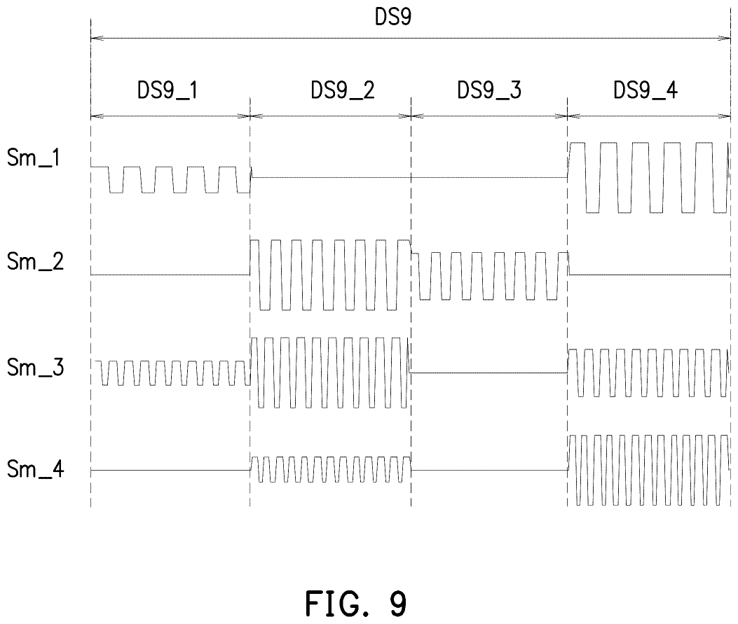

FIG. 9 is a schematic diagram of the modulated downlink signals Sm_1 to Sm_4 illustrated according to another embodiment of the disclosure. A horizontal axis in FIG. 9 represents time. In the embodiment shown in FIG. 9, the quantity m of the modulated downlink signals Sm_1 to Sm_m is assumed to be 4. The modulated downlink signals Sm_1 to Sm_4 shown in FIG. 9 may be deduced by referring to the related descriptions of the modulated downlink signals Sm_1 to Sm_4 shown in FIG. 6, and a downlink slot DS9 shown in FIG. 9 may be deduced by referring to the related descriptions of any one of the downlink slots DS7_1 to DS7_3 shown in FIG. 7, so the details of which are not reproduced here. FIG. 9 shows an example of each downlink slot including multiple sub-slots that are mutually continuous. Assume that 1 stylus frame includes N downlink slots. Assume that one downlink slot is divided into M sub-slots. Assume that a quantity of downlink frequencies (that is, the quantity m of the modulated downlink signals Sm_1 to Sm_m) is m. Assume that the ASK may modulate 2\hat{ }B signal amplitudes. Based on the ASK, each stylus frame may transmit a total of (m*N*M*B) bits.

For example, referring to FIG. 2 and FIG. 9, assume that the frequency allocator 121 divides a transmission data to be given to the sensing panel 110 into the 4 frequency channel data D_1, D_2, D_3 and D_4. The downlink slot DS9 includes sub-slots DS9_1, DS9_2, DS9_3 and DS9_4 that are mutually continuous. The modulation circuit 122 performs the ASK modulation based on the multiple frequency channel data D_1 to D_4 to modulate the modulated downlink signals Sm_1 to Sm_4 for the antenna portion 123 in the sub-slots DS9_1 to DS9_4 of the downlink slot DS9. The modulation circuit 122 respectively modulates a first portion, a second portion, a third portion and a fourth portion of the frequency channel data D_1 (assumed to be bit values “01”, “00”, “00” and “11”) in the sub-slots DS9_1 to DS9_4 of the modulated downlink signal Sm_1 as shown in FIG. 9. Similarly, a first portion, a second portion, a third portion and a fourth portion of the frequency channel data D_2 (assumed to be bit values “00”, “11”, “10” and “00”) are respectively modulated in the sub-slots DS9_1 to DS9_4 of the modulated downlink signal Sm_2. A first portion, a second portion, a third portion and a fourth portion of the frequency channel data D_3 (assumed to be bit values “01”, “11”, “00” and “10”) are respectively modulated in the sub-slots DS9_1 to DS9_4 of the modulated downlink signal Sm_3. A first portion, a second portion, a third portion and a fourth portion of the frequency channel data D_4 (assumed to be bit values “00”, “01”, “00” and “11”) are respectively modulated in the sub-slots DS9_1 to DS9_4 of the modulated downlink signal Sm_4.

In some embodiments, the sensing panel 110 may detect the modulated downlink signals Sm_1 to Sm_m in the sub-slots DS9_1 to DS9_4 to perform coordinate positioning. For example (but not limited thereto), the sensing panel 110 may detect the modulated downlink signal Sm_1 in the sub-slot DS9_1, detect the modulated downlink signal Sm_3 in the sub-slot DS9_2, detect the modulated downlink signal Sm_2 in the sub-slot DS9_3, and detect the modulated downlink signal Sm_4 in the sub-slot DS9_4 to perform positioning on the coordinates of the stylus 120. In other embodiments, the antenna portion 123 may mix the modulated downlink signals Sm_1 to Sm_m to generate the downlink signals DLs to the sensing panel 110. Based on this, the sensing panel 110 may detect and use the downlink signals DLs that are mixed to perform coordinate positioning.

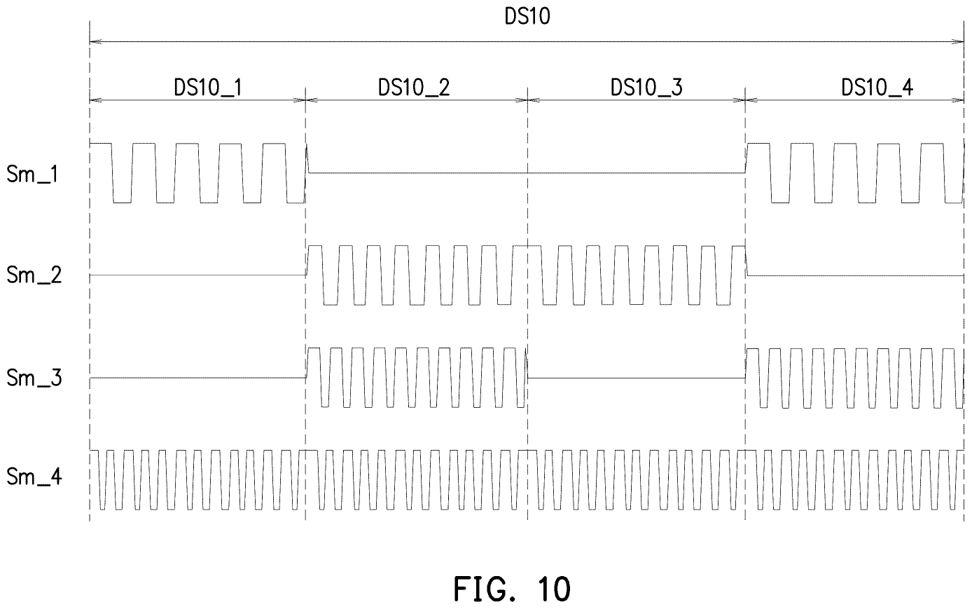

At least one of the modulated downlink signals Sm_1 to Sm_m may be used to serve as a positioning signal for the sensing panel 110. For example, FIG. 10 is a schematic diagram of the modulated downlink signals Sm_1 to Sm_4 according to another embodiment of the disclosure. A horizontal axis in FIG. 10 represents time. The modulated downlink signals Sm_1 to Sm_4, a downlink slot DS10, and sub-slots DS10_1, DS10_2, DS10_3, DS10_4 shown in FIG. 10 may be deduced by referring to the related descriptions of the modulated downlink signals Sm_1 to Sm_4, the downlink slot DS8, and the sub-slots DS8_1 to DS8_4 shown in FIG. 8, so the details of which are not reproduced here. In the embodiment shown in FIG. 10, the stylus 120 uses a specific frequency signal (such as the modulated downlink signal Sm_4 shown in FIG. 10) for the sensing panel 110 to perform coordinate positioning.

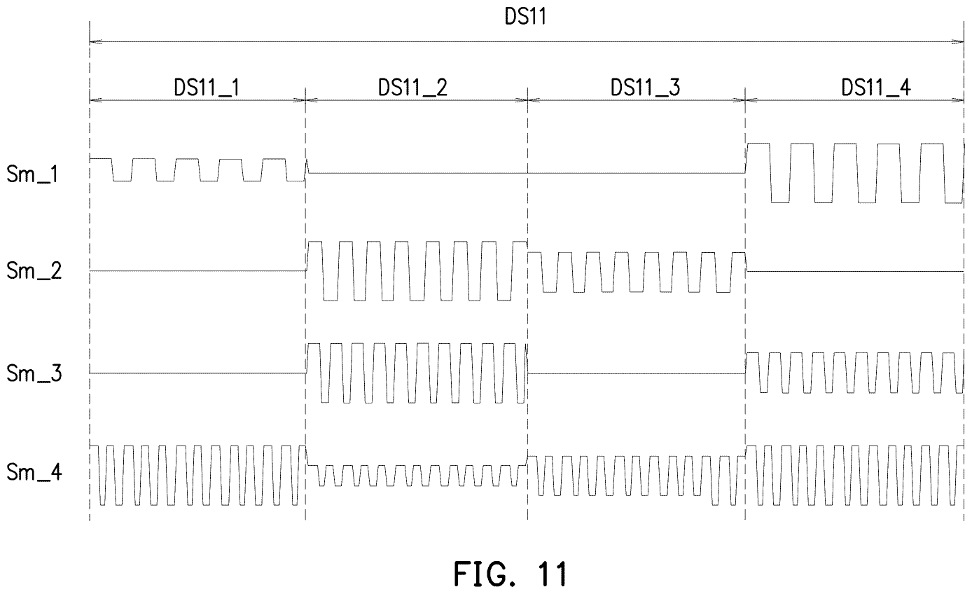

FIG. 11 is a schematic diagram of the modulated downlink signals Sm_1 to Sm_4 according to yet another embodiment of the disclosure. A horizontal axis in FIG. 11 represents time. The modulated downlink signals Sm_1 to Sm_4, a downlink slot DS11, and sub-slots DS11_1, DS11_2, DS11_3, DS11_4 shown in FIG. 11 may be deduced by referring to the related descriptions of the modulated downlink signals Sm_1 to Sm_4, the downlink slot DS9, and the sub-slots DS9_1 to DS9_4 shown in FIG. 9, so the details of which are not reproduced here. In the embodiment shown in FIG. 11, the stylus 120 uses a specific frequency signal with an amplitude change (such as the modulated downlink signal Sm_4 shown in FIG. 11) for the sensing panel 110 to perform coordinate positioning.

In summary, the stylus 120 utilizes a technique of frequency bands, amplitudes, and time intervals of the downlink signals DLs to encode/modulate the transmission data to be given to the sensing panel 110 to achieve the effect of expanded transmission capacity. In some embodiments, the downlink signals DLs may be used for active stylus data transmission and coordinate positioning at the same time. The quantity of the frequency bands, the amplitudes, and the time intervals of the downlink signals DLs may be determined according to product application planning, so the stylus 120 has scalability. The antenna position of the stylus 120 is not limited to the location of the tip or the ring portion. The stylus 120 has the downlink signals DLs with different downlink frequencies, which are not limited to a completely mixed wave form. In some embodiments, the stylus 120 may utilize a form of partial mixing or multiple sets of single-frequency signals to transmit the downlink signals DLs.

Although the disclosure has been disclosed in the above embodiments, the embodiments are not intended to limit the disclosure. Persons skilled in the art may make some changes and modifications without departing from the spirit and scope of the disclosure. Therefore, the protection scope of the disclosure shall be defined by the appended claims.

What is claimed is:

1. A stylus comprising:
an antenna portion;
a frequency allocator dividing a transmission data to be given to a sensing panel into a plurality of frequency channel data, wherein the plurality of frequency channel data respectively correspond to different downlink frequencies; and
a modulation circuit coupled to the frequency allocator and the antenna portion, wherein the modulation circuit modulates each of a plurality of carriers having different downlink frequencies based on a corresponding one among the plurality of frequency channel data to generate a plurality of modulated downlink signals having different downlink frequencies for the antenna portion, and the antenna portion emits the plurality of modulated downlink signals to the sensing panel.

2. The stylus according to claim 1, wherein the modulation circuit performs an on-off keying modulation on each of the carriers based on a corresponding one among the plurality of frequency channel data to generate the plurality of modulated downlink signals having different downlink frequencies for the antenna portion.

3. The stylus according to claim 1, wherein the modulation circuit performs an amplitude-shift keying modulation on each of the carriers based on a corresponding one among the plurality of frequency channel data to generate the plurality of modulated downlink signals having different downlink frequencies for the antenna portion.

4. The stylus according to claim 1, wherein the sensing panel is a touch display panel, each of at least one discontinuous downlink slot is located between two adjacent corresponding display driving periods in a display frame period of the touch display panel, and the modulation circuit modulates the plurality of modulated downlink signals for the antenna portion in the at least one downlink slot based on the plurality of frequency channel data.

5. The stylus according to claim 4, wherein all bits of a symbol in the transmission data are allocated to a same corresponding one among the plurality of frequency channel data, and the modulation circuit carries the bits of the symbol on a same corresponding one among the plurality of modulated downlink signals within the at least one downlink slot.

6. The stylus according to claim 4, wherein a plurality of bits of a symbol in the transmission data are allocated to different ones among the plurality of frequency channel data, and the modulation circuit carries the bits of the symbol on different ones among the plurality of modulated downlink signals within a same one among the at least one downlink slot.

7. The stylus according to claim 4, wherein the at least one downlink slot comprises a first downlink slot, the plurality of modulated downlink signals comprise a first downlink signal, the plurality of frequency channel data comprise a first frequency channel data, and the modulation circuit modulates a first portion of the first frequency channel data on the first downlink slot of the first downlink signal.

8. The stylus according to claim 7, wherein the at least one downlink slot further comprises a second downlink slot and a third downlink slot, and the modulation circuit respectively modulates a second portion and a third portion of the first frequency channel data on the second downlink slot and the third downlink slot of the first downlink signal.

9. The stylus according to claim 1, wherein the plurality of modulated downlink signals comprise a first downlink signal and a second downlink signal having different downlink frequencies, the plurality of frequency channel data comprise a first frequency channel data and a second frequency channel data corresponding to different downlink frequencies, the modulation circuit modulates the first frequency channel data on the first downlink signal, and the modulation circuit modulates the second frequency channel data on the second downlink signal.

10. The stylus according to claim 9, wherein the plurality of modulated downlink signals further comprise a third downlink signal and a fourth downlink signal having different downlink frequencies, the plurality of frequency channel data further comprise a third frequency channel data and a fourth frequency channel data corresponding to different downlink frequencies, the modulation circuit modulates the third frequency channel data on the third downlink signal, and the modulation circuit modulates the fourth frequency channel data on the fourth downlink signal.

11. The stylus according to claim 1, wherein the sensing panel is a touch display panel, each of a plurality of downlink slots that are mutually discontinuous is located between two adjacent corresponding display driving periods in a display frame period of the touch display panel, each of the downlink slots comprises a plurality of sub-slots that are mutually continuous, and the modulation circuit modulates the plurality of modulated downlink signals for the antenna portion in the sub-slots of the downlink slots based on the plurality of frequency channel data.

12. The stylus according to claim 11, wherein all bits of a symbol in the transmission data are allocated to a same corresponding one among the plurality of frequency channel data, and the modulation circuit carries the bits of the symbol on a same corresponding one among the plurality of modulated downlink signals within the sub-slots.

13. The stylus according to claim 11, wherein a plurality of bits of a symbol in the transmission data are allocated to different ones among the plurality of frequency channel data, and the modulation circuit carries the bits of the symbol on different ones among the plurality of modulated downlink signals within a same one among the sub-slots.

14. The stylus according to claim 1, wherein at least one of the plurality of modulated downlink signals is used to serve as a positioning signal for the sensing panel.

15. The stylus according to claim 1, wherein the antenna portion comprises:
a tip antenna; and
a multiplexer having an output terminal coupled to the tip antenna, wherein a plurality of input terminals of the multiplexer are coupled to the modulation circuit to receive the plurality of modulated downlink signals, the multiplexer outputs the plurality of modulated downlink signals to the tip antenna in a time-division manner, and the tip antenna emits the plurality of modulated downlink signals output by the multiplexer to the sensing panel.

16. The stylus according to claim 1, wherein the antenna portion comprises:
a tip antenna;
at least one ring portion antenna; and
a multiplexer having a plurality of output terminals respectively coupled to the tip antenna and the at least one ring portion antenna, wherein a plurality of input terminals of the multiplexer are coupled to the modulation circuit to receive the plurality of modulated downlink signals, the multiplexer selectively outputs each of the plurality of modulated downlink signals to a corresponding antenna among the tip antenna and the at least one ring portion antenna, and the tip antenna and the at least one ring portion antenna emit the plurality of modulated downlink signals output by the multiplexer to the sensing panel.

17. A downlink transmission method of a stylus comprising:
dividing a transmission data to be given to a sensing panel into a plurality of frequency channel data by a frequency allocator of the stylus, wherein the plurality of frequency channel data respectively correspond to different downlink frequencies;
modulating each of a plurality of carriers having different downlink frequencies based on a corresponding one among the plurality of frequency channel data by a modulation circuit of the stylus to generate a plurality of modulated downlink signals having different downlink frequencies for an antenna portion of the stylus, wherein the modulation circuit is coupled to the frequency allocator and the antenna portion; and
emitting the plurality of modulated downlink signals to the sensing panel by the antenna portion.

18. The downlink transmission method according to claim 17, further comprising:
performing an on-off keying modulation on each of the carriers based on a corresponding one among the plurality of frequency channel data to generate the plurality of modulated downlink signals having different downlink frequencies for the antenna portion.

19. The downlink transmission method according to claim 17, further comprising:
performing an amplitude-shift keying modulation on each of the carriers based on a corresponding one among the plurality of frequency channel data by the modulation circuit to generate the plurality of modulated downlink signals having different downlink frequencies for the antenna portion.

20. The downlink transmission method according to claim 17, wherein the sensing panel is a touch display panel, and the downlink transmission method further comprises:
modulating the plurality of modulated downlink signals for the antenna portion in a plurality of downlink slots that are mutually discontinuous based on the plurality of frequency channel data, wherein each of the downlink slots is located between two adjacent corresponding display driving periods in a display frame period of the touch display panel.

21. The downlink transmission method according to claim 20, further comprising:
allocating all bits of a symbol in the transmission data to a same corresponding one among the plurality of frequency channel data; and
carrying the bits of the symbol on a same corresponding one among the plurality of modulated downlink signals by the modulation circuit within the downlink slots.

22. The downlink transmission method according to claim 20, further comprising:
allocating a plurality of bits of a symbol in the transmission data to different ones among the plurality of frequency channel data; and
carrying the bits of the symbol on different ones among the plurality of modulated downlink signals within a same one among the downlink slots by the modulation circuit.

23. The downlink transmission method according to claim 17, wherein the sensing panel is a touch display panel, each of a plurality of downlink slots that are mutually discontinuous is located between two adjacent corresponding display driving periods in a display frame period of the touch display panel, each of the downlink slots comprises a plurality of sub-slots that are mutually continuous, and the downlink transmission method further comprises:
modulating the plurality of modulated downlink signals for the antenna portion in the sub-slots of the downlink slots based on the plurality of frequency channel data by the modulation circuit.

24. The downlink transmission method according to claim 23, further comprising:
allocating all the bits of a symbol in the transmission data to a same corresponding one among the plurality of frequency channel data; and
carrying the bits of the symbol on a same corresponding one among the plurality of modulated downlink signals by the modulation circuit within the sub-slots.

25. The downlink transmission method according to claim 23, further comprising:
allocating the plurality of bits of a symbol in the transmission data to different ones among the plurality of frequency channel data; and
carrying the bits of the symbol on different ones among the plurality of modulated downlink signals within a same one among the sub-slots by the modulation circuit.

26. The downlink transmission method according to claim 17, wherein at least one of the plurality of modulated downlink signals is used to serve as a positioning signal for the sensing panel.
